(19) United States
(12) Patent Application Publication
(10) Pub. No.: US 2014/0018272 A1
(43) Pub. Date: Jan. 16, 2014

(54) Polyalkylene Glycol Based Heat Transfer Fluids and Monofluid Engine Oils

(71) Applicants: Johan A. Thoea, Anterwerpen (BE); Mathias Woydt, Berlin (DE); Daniel F. Zweifel, Hirzel (CH)

(72) Inventors: Johan A. Thoea, Anterwerpen (BE); Mathias Woydt, Berlin (DE); Daniel F. Zweifel, Hirzel (CH)

(73) Assignee: Dow Global Technologies LLC, Midland, MI (US)

(21) Appl. No.: 14/001,211

(22) PCT Filed: Mar. 15, 2012
(86) PCT No.: PCT/US2012/029265

§ 371 Date: Oct. 3, 2013

Related U.S. Application Data
(60) Provisional application No. 61/466,685, filed on Mar. 23, 2011.

(51) Int. Cl. C09K 5/10

(52) U.S. Cl. CPC C09K 5/10
USPC 508/508; 252/77

(57) ABSTRACT

A heat transfer fluid composition comprising a polyalkylene glycol initiated by a hydric initiator having a functionality of at least 1 and extended with ethylene oxide, wherein the polyalkylene glycol comprises at least 30 percent by weight ethylene oxide and having a volumetric heat capacity at 100° C. of at least 2.0 J/cm³-K; and an additive package which comprises an acid scavenger, wherein the acid scavenger is an aspartic acid, aspartic acid amide, a Group V aspartic acid salt, their derivatives, or a combination thereof is provided. Also provided are such fluids which meet the bio-no-tox criteria of European Community directive EC/1999/45 (as amended by EC/2006/8). Further provided are monofluid-type engine lubricating and cooling fluids comprising such heat transfer fluid.

### FIELD OF INVENTION

The instant invention relates to polyalkylene glycol-based heat transfer fluids and monofluid engine oils made therefrom.

### BACKGROUND OF THE INVENTION

Engine oils are used for multiple purposes. In one aspect, engine oils are used to lubricate moving parts in an engine. In another aspect, engine oils are used to cool critical engine components, such as the piston crown and the crank shaft bearing. Of particular current interest is the ability to cool moving parts in turbo-charged engines, especially in down-sized passenger car engines, including those having a KW/1 of greater than or equal to >85 kW/1 and/or a Break Mean Effective Pressure (BMEP) of greater than 2.5 MPa. Of further interest is improved cooling ability in an effort to improve fuel economy. One solution to improving fuel economy would be to reduce the flow of the oil pump, thereby reducing the thermal load on the engine.

The instant invention provides a lubricant composition with which the flow of the oil pump may be reduced, specifically the flow of the oil pump may be reduced with equal heat transfer results and fuel economy improvements. Another benefit of the inventive lubricant is that it provides lower temperature build up during shearing in tribosystems resulting in a lower viscosity decrease and better film height. The density and the thermal capacity of polyalkylene glycols are up to 32% higher when compared to hydrocarbon-based mineral oil. The thermal conductivity of polyalkylene glycols ranges up to 13% above that of hydrocarbon-based mineral oil. Higher volumetric heat capacity favors the following engine concepts:
(a) mono-fluid engine concepts, which combine lubricants and coolants in one circuit, thereby lessening the number of pumps needed as well as related power supplies, seals and bores; and,
(b) highly supercharged engines, where the piston bowl, connecting rods and crankshaft bearing need cooling.

A further need exists for engine oils and lubricants with the ability to meet bio-no-tox requirements set forth in, for example, European Community directive EC/1999/45 as amended by EC/2006/8. The criteria in directive EC/1999/45 (as amended by EC/2006/8) are incorporated herein by reference as the criteria for determining whether a polyalkylene glycol is in accordance with certain embodiments of this invention. The lubricant composition of the instant invention further addresses these needs, providing excellent biodegradation and aquatic toxicity results according to OECD/ISO/ASTM test methods.

Further, there is a growing desire to increase the use of renewable sources in engine lubricants and oils. The polyalkylene glycol useful in the inventive compositions may be initiated by compounds derived from renewable resources, thereby meeting this need.

### SUMMARY OF THE INVENTION

The instant invention is a heat transfer fluid composition and engine oils made therefrom.

In one embodiment, the instant invention provides a heat transfer fluid composition comprising: a polyalkylene glycol initiated by a hydric initiator having a functionality of at least 1 and extended with ethylene oxide, wherein the polyalkylene glycol comprises at least 30 percent by weight ethylene oxide and having a volumetric heat capacity at 100° C. of at least 2.0 J/cm³-K; and an additive package which comprises an acid scavenger, wherein the acid scavenger is an aspartic acid, aspartic acid amide, a Group V aspartic acid salt, their derivatives, or a combination thereof.

In an alternative embodiment, the instant invention further provides a method of lubricating and cooling a monofluid type engine comprising using the heat transfer fluid composition of any one of the preceding or foregoing embodiments as a lubricating and cooling fluid therein.

In an alternative embodiment, the instant invention provides a heat transfer fluid composition and method of lubricating and cooling a monofluid type engine, in accordance with any of the preceding embodiments, except that the additive package further comprises: (i) at least one extreme pressure anti-wear additive; (ii) at least one anti-corrosion additive; (iii) at least one antioxidant; (iv) at least one friction modifier; (v) at least one additional acid scavenger; or (vi) any combination of two or more of (i) through (v) hereof.

In an alternative embodiment, the instant invention provides a heat transfer fluid composition and method of lubricating and cooling a monofluid type engine, in accordance with any of the preceding embodiments, except that the additive package is soluble in the polyalkylene glycol at 25° C.

In an alternative embodiment, the instant invention provides a heat transfer fluid composition and method of lubricating and cooling a monofluid type engine, in accordance with any of the preceding embodiments, except that the additive package meets bio-no-tox criteria of European Community directive EC/1999/45 (as amended by EC/2006/8) and does not deteriorate bio-no-tox properties of the polyalkylene glycol to a point where the heat transfer fluid composition does not meet the bio-no-tox criteria of European Community directive EC/1994/45 (as amended by EC/2006/8).

In an alternative embodiment, the instant invention provides a heat transfer fluid composition and method of lubricating and cooling a monofluid type engine, in accordance with any of the preceding embodiments, except that the Group V aspartic acid salt is an amine salt.

In an alternative embodiment, the instant invention provides a heat transfer fluid composition and method of lubricating and cooling a monofluid type engine, in accordance with any of the preceding embodiments, except that the polyalkylene glycol comprises at least 60 percent by weight ethylene oxide.

In an alternative embodiment, the instant invention provides a heat transfer fluid composition and method of lubricating and cooling a monofluid type engine, in accordance with any of the preceding embodiments, except that the polyalkylene glycol comprises at least 90 percent by weight ethylene oxide.

In an alternative embodiment, the instant invention provides a heat transfer fluid composition and method of lubricating and cooling a monofluid type engine, in accordance with any of the preceding embodiments, except that the hydric initiator is selected from the group consisting of 1,4-butanediol derived from succinic acid; propylene glycol derived from glycerin or one or more carbohydrates; teraglycerin; hexaglycerin; decaglycerin; glycerin derived from a renewable resource; and monopropylene glycol derived from glycerin which has been derived from a renewable resource.

In an alternative embodiment, the instant invention provides a heat transfer fluid composition and method of lubricating and cooling a monofluid type engine, in accordance with any of the preceding embodiments, except that the hydric initiator has a functionality of at least 2.

In an alternative embodiment, the instant invention provides a heat transfer fluid composition and method of lubricating and cooling a monofluid type engine, in accordance with any of the preceding embodiments, except that the hydric initiator has a functionality of at least 3.

In an alternative embodiment, the instant invention provides a heat transfer fluid composition and method of lubricating and cooling a monofluid type engine, in accordance with any of the preceding embodiments, except that the polyalkene glycol is produced from ethylene oxide and at least one alkylene oxide selected from the group consisting of alkylene oxides having from 3 to 12 carbons.

In an alternative embodiment, the instant invention provides a heat transfer fluid composition and method of lubricating and cooling a monofluid type engine, in accordance with any of the preceding embodiments, except that the polyalkene glycol is produced from ethylene oxide and propylene oxide.

In an alternative embodiment, the instant invention provides a heat transfer fluid composition and method of lubricating and cooling a monofluid type engine, in accordance with any of the preceding embodiments, except that the polyalkylene glycol has a molecular weight from 200 to 2500 g/mol.

In an alternative embodiment, the instant invention provides a heat transfer fluid composition and method of lubricating and cooling a monofluid type engine, in accordance with any of the preceding embodiments, except that the polyalkylene glycol has a molecular weight from 300 to 1000 g/mol.

In an alternative embodiment, the instant invention provides a heat transfer fluid composition and method of lubricating and cooling a monofluid type engine, in accordance with any of the preceding embodiments, except that the polyalkylene glycol has a molecular weight from 250 to 2000 g/mol.

In an alternative embodiment, the instant invention provides a heat transfer fluid composition and method of lubricating and cooling a monofluid type engine, in accordance with any of the preceding embodiments, except that the hydric initiator is derived from one or more vegetable oils.

In an alternative embodiment, the instant invention provides a heat transfer fluid composition and method of lubricating and cooling a monofluid type engine, in accordance with any of the preceding embodiments, except that the polyalkylene glycol has a volumetric heat capacity of at least 2.3 J/cm³-K.

In an alternative embodiment, the instant invention provides a heat transfer fluid composition and method of lubricating and cooling a monofluid type engine, in accordance with any of the preceding embodiments, except that the polyalkylene glycol comprises at least 8 molar percent of units derived from renewable resources.

In an alternative embodiment, the instant invention provides a heat transfer fluid composition and method of lubricating and cooling a monofluid type engine, in accordance with any of the preceding embodiments, except that the polyalkylene glycol meets bio-no-tox criteria of European Community directive EC/1999/45 (as amended by EC/2006/8).

In an alternative embodiment, the instant invention provides a heat transfer fluid composition and method of lubricating and cooling a monofluid type engine, in accordance with any of the preceding embodiments, except that the heat transfer fluid meets bio-no-tox criteria of European Community directive EC/1999/45 (as amended by EC/2006/8).

In an alternative embodiment, the instant invention provides an engine oil for a monofluid concept engine comprising the heat transfer fluid composition of any one of the preceding embodiments.

In an alternative embodiment, the instant invention provides a heat transfer fluid composition and method of lubricating and cooling a monofluid type engine, in accordance with any of the preceding embodiments, except that the polyalkylene glycol meets biodegradability standards of ASTM D7665-10.

In an alternative embodiment, the instant invention provides a heat transfer fluid composition and method of lubricating and cooling a monofluid type engine, in accordance with any of the preceding embodiments, except that the heat transfer fluid meets biodegradability standards of ASTM D7665-10.

In an alternative embodiment, the instant invention provides a heat transfer fluid composition and method of lubricating and cooling a monofluid type engine, in accordance with any of the preceding embodiments, wherein the heat transfer fluid has a high thermal stability and oxidation resistance.

In an alternative embodiment, the instant invention provides a heat transfer fluid composition and method of lubricating and cooling a monofluid type engine, in accordance with any of the preceding embodiments, wherein the polyalkylene glycol is initiated by bio-based 1.4-butanediol derived from succinic acid.

In an alternative embodiment, the instant invention provides a heat transfer fluid composition and method of lubricating and cooling a monofluid type engine, in accordance with any of the preceding embodiments, wherein the polyalkylene glycol has at least 10 mole percentage, 12 mole percentage or 14 mole percentage derived from renewable resources.

### BRIEF DESCRIPTION OF THE DRAWINGS

For the purpose of illustrating the invention, there is shown in the drawings a form that is exemplary; it being understood, however, that this invention is not limited to the precise arrangements and instrumentalities shown.

FIG. 1 is a graph illustrating volumetric heat capacity versus temperature for several samples including: (1) Comparative Example 1 is shown by vertical line marks; (2) Comparative Example 2 is shown by diamond marks; (3) Comparative Example 3 is shown by triangle marks; (4) Comparative Example 4 is shown by an X mark; (4) Inventive Example 1 is shown by dot marks; (6) Inventive Example 2 is shown by square marks; and (5) Inventive Example 3 is shown by * mark.

### DETAILED DESCRIPTION OF THE INVENTION

The instant invention provides polyalkylene glycol-based heat transfer fluid compositions and monofluid engine oils.

The composition according to the present invention comprises: a polyalkylene glycol initiated by a hydric initiator having a functionality of at least 1 and extended with ethylene oxide, wherein the polyalkylene glycol comprises at least 30 percent by weight ethylene oxide and having a volumetric heat capacity at 100° C. of at least 2.0 J/cm³-K; and an additive package which comprises an acid scavenger, wherein the acid scavenger is an aspartic acid, aspartic acid amide, a Group V aspartic acid salt, their derivatives, or a combination thereof.

The polyalkylene glycol useful in embodiments of the inventive composition comprises at least 30 percent by weight units derived from ethylene oxide. All individual values and subranges from at least 30 percent by weight are included herein and disclosed herein; for example, the weight percent of units derived from ethylene oxide may be from a lower limit of 30, 40, 50, 60, 70, 80, or 90%. For example, the weight percent of units derived from ethylene oxide may be at least 30%, or in the alternative, the weight percent of units derived from ethylene oxide may be at least 40%, or in the alternative, the weight percent of units derived from ethylene oxide may be at least 50%, or in the alternative, the weight percent of units derived from ethylene oxide may be at least 60%, or in the alternative, the weight percent of units derived from ethylene oxide may be at least 70%, or in the alternative, the weight percent of units derived from ethylene oxide may be at least 80%, or in the alternative, the weight percent of units derived from ethylene oxide may be at least 90%.

The polyalkylene glycol may, in some embodiments of the inventive composition, further comprise units derived from a C₃-C₁₂ 1,2-alkylene oxides (vicinal epoxides) and combinations thereof, including for example, propylene oxide, butylene oxides, and cyclohexene oxide. All individual values and subranges from C₃-C₁₂ alkylene oxides are included herein and disclosed herein; for example, the polyalkylene glycol may further comprise units derived from C₃-C₁₂ alkylene oxides, or in the alternative, the polyalkylene glycol may further comprise units derived from C₃-C₁₀ alkylene oxides, or in the alternative, the polyalkylene glycol may further comprise units derived from C₃-C₈ alkylene oxides, or in the alternative, the polyalkylene glycol may further comprise units derived from C₃-C₆ alkylene oxides.

Mixtures of these 1,2-oxides are also useful in preparing polyalkylene glycols useful in embodiments of the inventive composition. A polyalkylene glycol may be formed by known techniques in which a hydric initiator is reacted with a single 1,2-oxide or a mixture of two or more of the 1,2-oxides. If desired, the initiator may be first oxyalkylated with one 1,2-oxide, followed by oxyalkylation with a different 1,2-oxide or a mixture of 1,2-oxides. The oxyalkylated initiator can be further oxyalkylated with a still different 1,2-oxide. For convenience, “mixture,” when applied to a polyalkylene glycol containing a mixture of 1,2-oxides, includes both random and/or block polyethers such as those prepared by: (1) random addition obtained by simultaneously reacting two or more 1,2-oxides with the initiator; (2) block addition in which the initiator reacts first with one 1,2-oxide and then with a second 1,2-oxide, and (3) block addition in which the initiator first reacts with a first 1,2-oxide followed by random addition wherein the initiator reacts with a combination of the first 1,2-oxide and a second 1,2-oxide.

Hydric initiators useful in embodiments of the invention include any hydric initiator having a functionality of at least 1. All individual values and subranges from at least 1 are included herein and disclosed herein; for example, the functionality of the hydric initiator can be from a lower limit of 1, 2, 3, 4, 5, or 6. For example, the functionality of the hydric initiator may be at least 1, or in the alternative, the functionality of the hydric initiator may be at least 2, or in the alternative, the functionality of the hydric initiator may be at least 3, or in the alternative, the functionality of the hydric initiator may be at least 4, or in the alternative, the functionality of the hydric initiator may be at least 5, or in the alternative, the functionality of the hydric initiator may be at least 6.

Hydric initiators useful in embodiments of the invention include aliphatic polyhydric alcohols containing between from two hydroxyl (OH) groups to six OH groups and from two carbon atoms (C₂) to eight carbon atoms (C₈) per molecule, as illustrated by compounds such as: ethylene glycol, propylene glycol, 2,3-butylene glycol, 1,3-butylene glycol, 1,4-butanediol, 1,3-propanediol, 1,5-pentane diol, 1,6-hexene diol, glycerol, trimethylolpropane, sorbitol, pentaerythritol, mixtures thereof and the like. Cyclic aliphatic polyhydric compounds such as starch, glucose, sucrose, and methyl glucoside may also be employed in polyalkylene glycol preparation. Each of the aforesaid polyhydric compounds and alcohols can be oxyalkylated with ethylene oxide (EO), propylene oxide (PO), butylene oxide (BO), cyclohexene oxide, glycidol, or mixtures thereof. For example, glycerol is first oxyalkylated with PO and the resulting polyalkylene glycol is then oxyalkylated with EO. Alternatively, glycerol is reacted with EO and the resulting polyalkylene glycol is reacted with PO and EO. Each of the above-mentioned polyhydric compounds can be reacted with mixtures of EO and PO or any two or more of any of the aforesaid 1,2-oxides, in the same manner. Techniques for preparing suitable polyethers from mixed 1,2-oxides are shown in U.S. Pat. Nos. 2,674,619; 2,733,272; 2,831,034, 2,948,575; and 3,036,118, the disclosures of which are incorporated herein by reference.

In some embodiments of the invention, the starting materials of polyalkylene glycol formation can be derived from naturally occurring materials, such as PO derived from monopropylene glycol (MPG) based on glycerin or EO derived from ethanol or tetrahydrofuran derived from hemicelluloses, all on a renewable base. Likewise, polyglycolesters can be made from renewable esters, such as vegetable oils or oleic sunflower oils, canola oil, soy oil their respective high oleic products, as well as castor oil, lesquerella oil, jathropa oil, and their derivatives.

Monopropylene glycol can also be derived by hydrogenolysis of glucose (sugar) or from D- or L-lactic acid.

Monohydric alcohols typically used as initiators include the lower acyclic alcohols such as methanol, ethanol, propanol, butanol, pentanol, hexanol, neopentanol, isobutanol, decanol, and the like, as well as higher acyclic alcohols derived from both natural and petrochemical sources with from 11 carbon atoms to 22 carbon atoms. As noted above, water can also be used as an initiator.

Preferred polyalkylene glycols for use in this invention include polyalkylene glycols produced by the polymerization of EO and PO onto an initiator.

In particular embodiments of the invention, the hydric initiators are selected from the group consisting of 1,4-butanediol derived from succinic acid; propylene glycol derived from glycerin or one or more carbohydrates; tetraglycerin; hexaglycerin; decaglycerin; glycerin derived from a renewable resource; and monopropylene glycol derived from glycerin which has been derived from a renewable resource.

The polyalkylene glycol useful in the inventive composition has a volumetric (isochoric) heat capacity at 100° C. of at least 2.0 J/cm³-K. All individual values and subranges from at least 2.0 J/cm³-K are included herein and disclosed herein; for example, the volumetric heat capacity of the polyalkylene glycol can be from a lower limit of 2.0, 2.05, 2.1, 2.15, 2.2, 2.25, 2.3, 2.4, 2.5, 2.55 or 2.6 J/cm³-K. For example, the volumetric heat capacity of the polyalkylene glycol may be at least 2.0 J/cm³-K, or the alternative, the volumetric heat capacity of the polyalkylene glycol may be at least 2.25 J/cm³-K, or in the alternative, the volumetric heat capacity of the polyalkylene glycol may be at least 2.3 J/cm³-K, or in the alternative, the volumetric heat capacity of the polyalkylene glycol may be at least 2.5 J/cm³-K volumetric heat capacity of the polyalkylene glycol.

In some embodiments of the inventive composition, the polyalkylene glycol has a molecular weight from 200 to 2500 g/mol. All individual values and subranges from 200 to 2500 g/mol are included herein and disclosed herein; for example, the [property] can be from a lower limit of 200, 500, 800, 1100, 1400, 1700, 2000, or 2300 g/mol to an upper limit of 300, 600, 900, 1200, 1500, 1800, 2100, 2400 or 2500 g/mol. For example, the molecular weight of the polyalkylene glycol may be in the range of from 200 to 2500 g/mol, or in the alternative, the molecular weight of the polyalkylene glycol may be in the range of from 250 to 2000 g/mol, or in the alternative, the molecular weight of the polyalkylene glycol may be in the range of from 300 to 1200 g/mol.

In some embodiments of the inventive composition, the polyalkylene glycol comprises at least 8 molar percent of units derived from renewable resources. All individual values and subranges from at least 8 molar percent are included herein and disclosed herein; for example, the amount of units derived from renewable resources can be from a lower limit of 8, 10, 12, 14, 16, 18 or 20 molar percent.

In some embodiments of the invention, the inventive composition meets bio-no-tox criteria of European Community directive EC/1999/45 (as amended by EC/2006/8).

In alternative embodiments of the invention, the composition may further comprise an additive package. In a preferred embodiment, the additive package does not degrade the ability of the heat transfer fluid composition to meet the bio-no-tox criteria of European Community directive EC/1999/45 (as amended by EC/2006/8). Such additive packages are disclosed in WO 2009/134716, the disclosure of which is incorporated herein by reference.

The additive package and each of its components preferably meet EC/1999/45 (as amended by EC/2006/8) bio-no-tox criteria and, more preferably, do not deteriorate as “package” the environmental performance of the heat transfer fluid or engine oil composition as stated in the EC/1999/45 (as amended by EC/2006/8) bio-no-tox criteria. The additive package and each of its components more preferably are soluble in the lubricant oil base stock, either at room temperature (nominally 25 degrees centigrade (° C.) or at an elevated temperature.

Esters and amides, and Group V (of The Periodic Table of the Elements) salts, of aspartic acid (collectively “aspartic acid derivatives”) are employed in the practice of this invention as a required heat transfer fluid composition component. Compounds used to form the esters and amides may include from 1 carbon atom to 25 carbon atoms, more typically from 1 carbon atom to 6 carbon atoms. For example, the carboxylic acid groups can be converted to methyl or ethyl esters (or a mixture thereof). One or both of the carboxylic acid groups of each aspartic acid functional group in the additive of this invention may be reacted to form such esters, amides, and Group V salts. Typically all the carboxylic acid groups are reacted to form such esters, amides, and Group V salts for acid scavengers used in various aspects or embodiments of this invention. The amount of such aspartic acid derivatives may vary. In general the amount is from 0.01 wt percent to 10 wt percent based on the total weight of the lubricant composition. More typically the amount is from 0.1 wt percent to 1 wt percent. Materials used to react with aspartic acid to form aspartic acid derivatives include compounds such as ammonia and other Group V compounds including ammonium, phosphonium, arsonium, and antimonium based materials, amines such as C₁-C₅₀ aliphatic amines such as methyl amine, ethyl amine, propyl amine, and butyl amine. The Group V salts appear to be superior to Group 1A cationic salts in terms of improved corrosion properties of the lubricant compositions. In addition, the Group V salts have improved solubility, relative to Group 1A salts, in PAG-based lubricant oil base stocks. The aspartic acid additives used herein include mono-acids and poly-acids (for example, those containing two or more aspartic acid functional groups (“polyaspartic acids”)).

Aspartic acid and polyaspartic acid refer to compounds that contain one or more aspartic acid groups. Typically the additives used herein contain≧two aspartic acid groups. Aspartic acid esters, amides, and Group V salts include compositions based on the following formula.

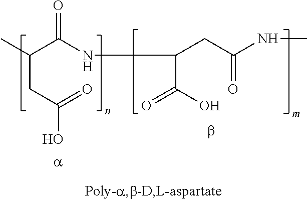

In the formula above, which describes a homo-polymer of aspartic acid, carboxylic acid groups or moieties can be converted to any of esters, amides, and Group V salts.

Polyaspartic acid compounds can be based on any organic structure which includes multiple aspartic acid groups attached thereto such as compounds of the following formula:

A-X-A

wherein A is aspartic acid ester, amide, or Group V salt, and X is a divalent C₂-C₂₅ hydrocarbon moiety. X may include additional elements such as oxygen, nitrogen, and sulfur. X can be a divalent alkane group, aliphatic group, or aromatic group, including alkane groups and aliphatic groups containing cyclic structures. X can also be based on di-cyclohexyl methane. Typically a nitrogen atom of aspartic acid forms a bond with a divalent hydrocarbon moiety. An exemplary polyaspartic acid compound has the following structure:

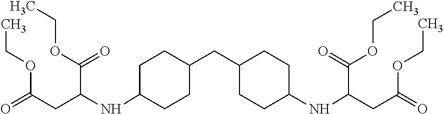 [SMILES: CCOC(=O)CC(NC1CCC(CC2CCC(NC(CC(=O)OCC)C(=O)OCC)CC2)CC1)C(=O)OCC]

which is aspartic acid N,N′-(methylene-d-4,1,-cyclohexanediyl)bis-tetraethyl ester. This polyaspartic acid ester appears to correspond to DESMOPHE NH1420 polyaspartic polyamino co-reactant (Bayer MaterialScience) and K-CORR 100 (King Industries).

The extreme pressure and anti-wear additives can be any conventional material so long as it meets the above EC/1999/45 bio-no-tox and solubility performance requirements. Representative examples of extreme pressure and anti-wear additives include, but are not limited to, dialkyl-dithio-carbamates of metals and methylene, esters of polyaspartic acid, triphenyl-thio-phosphates, diaryldisulfides, dialkyldisulfides, alkylarylsulfides, dibenzyldisulphide, and combinations thereof. Representative examples of preferred extreme pressure and anti-wear additives include, but are not limited to, dibenzyldisulfide (US FDA approved), O,O,O-triphenylphosphorothioate, Zn-di-n-butyldithiocarbamate, Mo-dibutyldithiocarbamate, and Zn-methylene-bis-dialkyldithiocarbamate, with dibenzyldisulfide being especially preferred. Representative examples of commercially available anti-wear additives that can be employed in the practice of this invention include but are not limited to IRGALUBE™ 63, 211, 232, and 353 (isopropylated triaryl phosphates); IRGALUBE™ 211 and 232 (nonylated triphenyl phosphorothionates); IRGALUBE™ 349 (amine phosphate); IRGALUBE™ 353 (dithiophosphate); IRGAFOS™ DDPP (iso-decyl diphenyl phosphite); and IRGAFOS™ OPH (di-n-octyl-phosphite).

The anti-corrosion additive (also known as a “metal deactivator”) may be any single compound or mixture of compounds that inhibits corrosion of metallic surfaces. The corrosion inhibitor can be any conventional material so long as it meets the above EC/1999/45 bio-no-tox and solubility performance requirements. Representative anti-corrosion additives include thiadiazoles and triazoles such as tolyltriazole; dimer and trimer acids such as those produced from tall oil fatty acids, oleic acid, and linoleic acid; alkenyl succinic acid and alkenyl succinic anhydride corrosion inhibitors such as tetrapropenylsuccinic acid, tetrapropenylsuccinic anhydride, dodecenylsuccinic acid, dodecenylsuccinic anhydride, hexadecenylsuccinic acid, and similar compounds; and half esters of C₈-C₂₄ alkenyl succinic acids with alcohols such as diols and polyglycols. Also useful are aminosuccinic acids or derivatives thereof. Preferred anti-corrosion additives include, but are not limited to, morpholine, N-methyl morpholine, N-ethyl morpholine, amino ethyl piperazine, monoethanol amine, 2 amino-2-methylpropanol (AMP), liquid tolutriazol derivatives such as 2,2′-methyl-1H-benzotriazol-1-yl-methyl-imino-bis and methyl-1H-benzotriazol, isopropyl hydroxylamine, IRGAMET™ 30 (liquid tolutriazol derivative), IRGAMET™ 30 (liquid triazol derivative), IRGAMET™ SBT 75 (tetrahydrobenzotriazole), IRGAMET™ 42 (tolutirazole derivative), IRGAMET™ BTZ (benzotriazole), IRGAMET™ TTZ (tolutriazole), imidazoline and its derivatives, IRGACOR™ DC11 (undecanedioic acid), IRGACOR™ DC 12 (dodecanedioic acid), IRGACOR™ L 184 (TEA neutralized polycarboxylic acid), IRGACOR™ L 190 (polycarboxylic acid), IRGACOR™ L12 (succinic acid ester), IRGACOR™ DSS G (n-oleyl sarcosine), and IRGACOR™ NPA (iso-nonyl phenoxy acetic acid). The lubricant composition preferably contains from 0.005 wt percent to 0.5 wt percent, and more preferably from 0.01 wt percent to 0.2 wt percent, of anti-corrosion additive, each wt percent being based upon total lubricant composition weight.

The antioxidant(s) can be any conventional antioxidant so long as it meets the above EC/1999/45 (as amended by EC/2006/8) bio-no-tox and solubility performance requirements. The antioxidant can vary widely, including compounds from classes such as amines and phenolics. The antioxidant can include a sterically hindered phenolic antioxidant (for example, an ortho-alkylated phenolic compound such as 2,6-di-tert-butylphenol, 4-methyl-2,6-di-tert-butylphenol, 2,4,6-tri-tert-butylphenol, 2-tert-butylphenol, 2,6-di-isopropylphenol, 2-methyl-6-tert-butylphenol, 2,4-dimethyl-6-tert-butylphenol, 4-(N,N-dimethylaminomethyl)-2,6-di-tert-butylphenol, 4-ethyl-2,6-di-tert-butylphenol, 2-methyl-6-styrylphenol, 2,6-di-styryl-4-nonylphenol, and their analogs and homologs). Representative examples of preferred antioxidants include, but are not limited to, amine antioxidants such as N-phenyl-1-naphthylamine N-phenylbenzenamine reaction products with 2,4,4-trimethylpentenes; phenothizines such as dibenzo-1,4,thiazine, 1,2-dihydroquinoline and poly(2,2,4-trimethyl-1,2-dihydroquinoline). Representative examples of commercially available and suitable antioxidants include, but are not limited to, IRGANOX™ L01, L06, L57, L93 (alkylated diphenyl amines and alkylated phenyl-naphtyl amines); IRGANOX™ L101, L107, L109, L115, L118, L135 (hindered phenolic antioxidants); IRGANOX™ L64, L74, L94, L134, and L150 (antioxidant blends); IRGFOS™ 168 (di-tert-butyl phenyl phosphate); IRGANOX™ E201 (alpha-tocopherol), and IRGANOX™ L93 (sulfur-containing aromatic amine antioxidant). The lubricant composition preferably contains from 0.01 wt percent to 1.0 wt percent, more preferably from 0.05 wt percent to 0.7 wt percent, of such antioxidant(s), each wt percent being based on total lubricant composition weight.

The additional acid scavenger is a single compound or a mixture of compounds that has an ability to scavenge acids. The acid scavenger can be any conventional material so long as it meets the above EC/1999/45 bio-no-tox and solubility performance requirements. Representative acid scavengers include, but are not limited to, sterically hindered carbo-diimides, such as those disclosed in FR 2,792,326, incorporated herein by reference.

The friction (rheology) modifier can be any conventional material so long as it meets the above EC/1999/45 bio-no-tox and solubility performance requirements. A representative non-limiting example of such a material is a copolymer of diphenylmethane-diisocyanate hexamethylene diamine and sterarylamine (for example, LUVODUR™ PVU-A). The lubricating compositions preferably contain from 0.01 wt percent to 1.0 wt percent, more preferably from 0.05 wt percent to 0.7 wt percent, of such friction modifiers, each wt percent being based on total lubricant composition weight.

In an alternative embodiment, the instant invention is an engine oil for a monofluid concept engine comprising the heat transfer fluid composition of any one of the foregoing embodiments.

In an alternative embodiment, the instant invention is a method for lubricating and cooling a monofluid type engine comprising using the heat transfer fluid composition of any one of the foregoing embodiments as a lubricating and cooling fluid therein.

### EXAMPLES

The following examples illustrate the present invention but are not intended to limit the scope of the invention.

Comparative Example 1 was a Castrol SAE 5W-30 factory fill oil (Europe, 2006) which is a petroleum hydrocarbon based engine oil.

Comparative Example 2 was a polyoxypropylene monoalcohol, prepared from an alkanol, such as polyglycol, and initiated with n-butanol, commercially available from CLARIANT as B01/20.

Comparative Example 3 was a polypropylene glycol-diol initiated using MPG derived from a renewable resource (Glycerine), available from BASF as LUPRANOL 450.

Comparative Example 4 was trifunctional polyglycol (glycerine based), initiated with glycerin, commercially available from BASF as LUPRANOL 3300.

Comparative Example 5 was a phenoxybenzene, commercially available from LANXESS, PVT., LTD. (India) as DIPHYL THT. Comparative Example 6 is a trifunctional polyglycol (glycerine initiated and ethoxylated) available from BASF as LUPRANOL VP9209.

Inventive Example 1 is blend of 75% TERRALOX WA46 and 25% BREOX 50A-140, TERRALOX WA46 is polyalkylene glycol comprising 64 percent by weight units derived from ethylene oxide and 18 percent by weight units derived from propylene oxide and 18 percent by weight of units derived from a 1,4-butanediol initiator and is available from The Dow Chemical Company. BREOX 50A-140 is an n-butanol initiated polyalkylene glycol with EO:PO/1:1 and is available from BASF (formerly, LaPorte Performance Chemicals).

Inventive Example 2 was 100% TERRALOX WA46.

Table 1 provides the weight percent of units derived from ethylene oxide (EO wt %), the weight percent of units derived from propylene oxide (PO wt %), molecular weight and pour point of each of the Inventive and Comparative Examples.

TABLE 1

| | | | Mol. Weight | |
|---|---|---|---|---|
| | EO | PO | g/mol | Pour Point |
| | Wt % | Wt % | [TOF-MALDI] | ° C. |
| Comparative Example 1 | n.a.* | n.a. | n.a. | −42 |
| Inventive Example 1 | 71 | 29 | 664 | −31 |
| | | | (TERRALOX) | |
| | | | and 1800 | |
| | | | (BREOX) | |
| Inventive Example 2 | 78 | 22 | 664 | −33 |
| Comparative Example 2 | 0 | 100 | 900 | −45 |
| Comparative Example 3 | 0 | 100 | 683 | −38 |
| Comparative Example 4 | 0 | 100 | 638 | −29 |
| Comparative Example 5 | n.a. | n.a. | 324 | −33 |
| Comparative Example 6 | 100 | 0 | 596 | −32 |

*n.a. = not applicable, because a hydrocarbon base oil.

Table 2 provides the viscosities, heat capacities, thermal conductivities, OECD 301 test results and OECD aquatic toxicity test results for the Inventive and Comparative Examples.

TABLE 2

| | | | | | | | OECD | | | |
|---|---|---|---|---|---|---|---|---|---|---|
| Polyalkylene | η₄₀ | η₁₀₀ | η₁₅₀ | Cₚ at | Cᵥ at | | 301B or | Aquatic toxicity | | |
| Glycol | mm²/s | mm²/s | mm²/s | 100° C. | 100° C. | λ at 100° C. | 302F* | OECD mg/l | | |
| Examples | (cSt) | (cSt) | (cSt) | J/g/K | J/cm³/K | W/m-K | % | 201(algae) 202(daphnia) 203(fish) | | |
| Comparative | 55.15 | 9.57 | 4.20 | 2.31 | 1.85 | 0.131 | 40 | 5 | 1,580 | 104 |
| Example 1 | | | | | | | | | | |
| Inventive Ex. | 47.38 | 9.94 | 4.81 | 2.14 | 2.06 | 0.152 | 64.46 | >100 | 688 | |
| 1 | | | | | | | | | | |
| Inventive Ex. | 49.6 | 8.44 | 3.7 | 2.27 | 2.30 | | 85 | >100 | >1.000 | |
| 2 | | | | | | | | | | |
| Comparative | 34.3 | 6.7 | 3.2 | 2.16 | 1.98 | | 74.46 | >100 | 694 | |
| Ex. 2 | | | | | | | | | | |
| Comparative | 29.95 | 4.49 | 1.95 | | | | 7.,0 | >100 | >1.000 | |
| Ex. 3 | | | | | | | | | | |
| Comparative | 119.1 | 8.95 | 3.04 | 2.30 | 2.27 | 0.152 | 75.0 | >100 | >1.000 | 4.600 |
| Ex. 4 | | | | | | | | | | |
| Comparative | 104.1 | 11.1 | 4.0 | 2.28 | 2.51 | | 24.6 | >100 | >1.000 | |
| Ex. 6 | | | | | | | | | | |
| Comparative | 21 | 3.30 | 1.55 | 1.81** | 1.72** | 0.107 | | | | |
| Ex. 5 | | | | | | | | | | |

*Either 301B or 301F was used dependent upon whether the example was water soluble or water insoluble.
**Heat capacities taken from BAYER data sheet for Comparative Example 5.

### TEST METHODS

Test methods include the following:

Molecular weight was determined by TOF-MALDI on a BRUKER III TOF-MALDI (available from the Bruker Corporation) as described in S. Weidner, J. Falkenhagen, S. Maltsev, V. Sauerland and M. Rinken, “A novel software tool for copolymer characterization by coupling of liquid chromatography with matrix-assisted laser desorption/ionization time-of-flight mass spectrometry’ in RAPID COMMUNICATIONS IN MASS SPECTROMETRY 2007, 21 (16), 2750-2758.

Pour point was determined in accordance with ASTM D97.

Viscosity was determined at 40, 100 and 150° C. in accordance with ASTM 445.

Isobaric heat capacity, Cp, and isochoric (constant volume) heat capacity, Cv, were measured using a power-compensated differential scanning calorimeter. The apparatus contains two crucibles: one filled with the sample, the other one empty. Both crucibles are heated with the same heating rate. The additional power that is necessary for the crucible which contains the sample is used to calculate the heat capacity of the sample. More details about the apparatus are given in E. S. Watson, J. J. O'Neill, and N. Brenner, “A Differential Scanning Calorimeter for Quantitative Differential Thermal Analysis,” Analytical Chemistry 36 (1963), pp. 1233-1238 and, G. Höhne, W. Hemminger, and H.-J. Flammersheim, “Differential Scanning Calorimetry” 2^{nd} edition, Springer-Verlag 2003.

Thermal conductivity, λ, was measured by using a plate apparatus. In this experiment, a known flow of thermal energy is driven through a gap between two parallel plates. The gap is filled with the sample. The temperature difference ΔT that is necessary for this heat flux is measured. Additional information regarding the apparatus used in this measurement is given in “Thermal Conductivity of a Wide Range of Alternative Refrigerants. Measured with an Improved Guarded Hot-Plate Apparatus,” by. U. Hammerschmidt, INT. J. THERMOPITYS. 16 (1995), pp. 1203-1211.

OECD 301B and F were used to measure % degradation in 28 hours.

OECD test methods 201, 202 and 203 were used to measure the aquatic toxicity of the lubricants to algae, daphnia and fish, respectively. The amount of lubricant (mg/l) to cause toxicity to such species is given. Therefore, higher levels indicate lower toxicity.

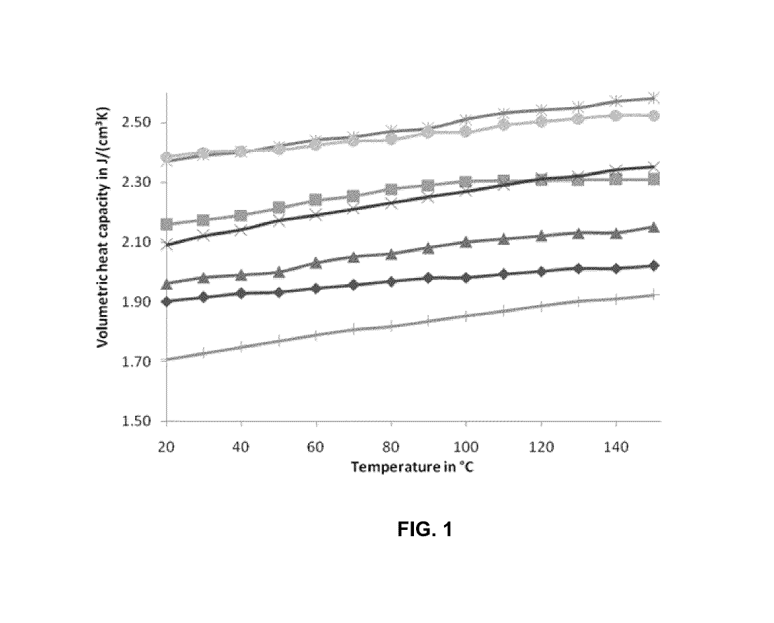

FIG. 1 illustrates that the volumetric heat capacity of polyalkyleneglycols with a high EO-content initiated by glycerine are between 10% to 32% above those measured with hydrocarbons or esters or hydrated terphenyl. Thus, inclusion of such a high ethylene oxide content polyalkylene glycol would enhances the heat capacity of a heat transfer fluid and/or engine cooling oil.

The present invention may be embodied in other forms without departing from the spirit and the essential attributes thereof, and, accordingly, reference should be made to the appended claims, rather than to the foregoing specification, as indicating the scope of the invention.

1. A heat transfer fluid composition comprising:
a first polyalkylene glycol initiated by a first hydric initiator having a functionality of at least 1 and extended with ethylene oxide,
a second polyalkylene glycol initiated by a second hydric initiator having a functionality of at least 1 and extended with ethylene oxide; wherein the first and second polyalkylene glycols are not the same polyalkylene glycol and the molecular weight of the first polyalkylene glycol differs from the molecular weight of the second polyalkylene glycol by at least 1000 g/mol; and
an additive package which comprises an acid scavenger, wherein the acid scavenger is an aspartic acid, aspartic acid amide, a Group V aspartic acid salt, their derivatives, or a combination thereof.

2. The heat transfer fluid composition according to claim 1, wherein the additive package further comprises:
(i) at least one extreme pressure anti-wear additive;
(ii) at least one anti-corrosion additive;
(iii) at least one antioxidant;
(iv) at least one friction modifier;
(v) at least one additional acid scavenger; or
(vi) any combination of two or more of (i) through (v) hereof.

3. The heat transfer fluid composition according to claim 1, wherein the additive package is soluble in the polyalkylene glycol at 25° C.

4. The heat transfer fluid composition according to claim 1, wherein the additive package meets bio-no-tox criteria of European Community directive EC/1999/45 (as amended by EC/2006/8) and does not deteriorate bio-no-tox properties of the polyalkylene glycol to a point where the heat transfer fluid composition does not meet the bio-no-tox criteria of European Community directive EC/1994/45 (as amended by EC/2006/8).

5. The heat transfer fluid composition according to claim 1, wherein the Group V aspartic acid salt is an amine salt.

6. The heat transfer fluid composition according to claim 1, wherein the first and/or second polyalkylene glycol comprises at least 60 percent by weight ethylene oxide.

7. The heat transfer fluid composition according to claim 1, wherein the first and/or second hydric initiator is selected from the group consisting of 1,4-butanediol derived from succinic acid; propylene glycol derived from glycerin or one or more carbohydrates; teraglycerin; hexaglycerin; decaglycerin; glycerin derived from a renewable resource; and monopropylene glycol derived from glycerin which has been derived from a renewable resource.

8. The heat transfer fluid composition according to claim 1, wherein the first and/or second hydric initiator has a functionality of at least 2.

9. The heat transfer fluid composition according to claim 1, wherein the first and/or second hydric initiator has a functionality of at least 3.

10. The heat transfer fluid composition according to claim 1, wherein the first and/or second polyalkene glycol is produced from ethylene oxide and at least one alkylene oxide selected from the group consisting of alkylene oxides having from 3 to 12 carbons.

11. The heat transfer fluid composition according to claim 1, wherein the first and/or second polyalkene glycol is produced from ethylene oxide and propylene oxide.

12. The heat transfer fluid composition according to claim 1, wherein the first and/or second polyalkene glycol has a molecular weight from 300 to 1200 g/mol.

13. The heat transfer fluid composition according to claim 1, wherein the first and/or second polyalkene glycol has a molecular weight from 250 to 2000 g/mol.

14. The heat transfer fluid composition according to claim 1, wherein the first and/or second hydric initiator is derived from one or more vegetable oils.

15. The heat transfer fluid composition according to claim 1, wherein the first and/or second polyalkene glycol has a volumetric heat capacity of at least 2.3 J/cm3-K.

16. The heat transfer fluid composition according to claim 1, wherein the first and/or second polyalkene glycol comprises at least 8 molar percent of units derived from renewable resources.

17. The heat transfer fluid composition according to claim 1, wherein the first and/or second polyalkylene glycol meets bio-no-tox criteria of European Community directive EC/1999/45 (as amended by EC/2006/8).

18. The heat transfer fluid composition according to claim 1, wherein the heat transfer fluid meets bio-no-tox criteria of European Community directive EC/1999/45 (as amended by EC/2006/8).

19. An engine oil for a monofluid concept engine comprising the heat transfer fluid composition of claim 1.

20. A method of lubricating and cooling a monofluid type engine comprising using the heat transfer fluid composition of claim 1 as a lubricating and cooling fluid therein.
